(19) United States
(12) Patent Application Publication
(10) Pub. No.: US 2025/0300876 A1
(43) Pub. Date: Sep. 25, 2025

(54) Control Plane Bridging for Maintenance End Point (MEP)

(71) Applicant: Arista Networks, Inc., Santa Clara, CA (US)

(72) Inventors: Vijay Mahadevan, Milpitas, CA (US); Utkarsha Verma, Fremont, CA (US); Ripon Bhattacharjee, Fremont, CA (US); Vamsi Anne, San Jose, CA (US); Victor Wen, San Jose, CA (US); Jeevan Kamisetty, San Jose, CA (US); Purushothaman Nandakumaran, Milpitas, CA (US)

(21) Appl. No.: 18/613,702

(22) Filed: Mar. 22, 2024

(51) Int. Cl. H04L 41/0604; H04L 12/46; H04L 41/0654

(52) U.S. Cl. CPC H04L 41/0627; H04L 12/4641; H04L 41/0654

(57) ABSTRACT

A network device may include a maintenance end point such as an up maintenance end point. The network device may include control circuitry that provides control plane bridging to facilitate the reception and transmission of continuity check messages by the up maintenance end point. For reception, the ingress processing pipeline for a peer interface with respect to the up maintenance end point may trap continuity check messages for control plane bridging. For transmission, the control circuitry may generate continuity check messages and perform control plane bridging prior to injecting the continuity check messages into the egress processing pipeline for the peer interface.

### BACKGROUND

A communication system includes multiple network devices that are interconnected to form a network for conveying network traffic between hosts. The network can include multiple maintenance domains for the purposes of connectivity fault management. In particular, maintenance end points (MEPs) in different maintenance domains are distributed appropriately across the network to facilitate Layer 2 continuity checks.

### BRIEF DESCRIPTION OF THE DRAWINGS

FIG. 1 is a diagram of an illustrative network having communicatively coupled network devices in accordance with some embodiments.

FIG. 2 is a diagram of an illustrative network device in accordance with some embodiments.

FIG. 3 is a diagram of an illustrative network device configured to perform continuity check operations in accordance with some embodiments.

FIG. 4 is a diagram of illustrative control circuitry and data plane processing circuitry configured to handle reception of a continuity check message in accordance with some embodiments.

FIG. 5 is a diagram of illustrative traffic trap information for an ingress pipeline of a peer interface in accordance with some embodiments.

FIG. 6 is a diagram of illustrative control plane bridging information for a received continuity check message in accordance with some embodiments.

FIG. 7 is a diagram of illustrative control circuitry and data plane processing circuitry configured to handle transmission of a continuity check message in accordance with some embodiments.

FIG. 8 is a diagram of illustrative control plane bridging information for a continuity check message to be transmitted in accordance with some embodiments.

FIG. 9 is a flowchart of illustrative operations for performing connectivity fault management in accordance with some embodiments.

### DETAILED DESCRIPTION

Network devices across a network may include interfaces on which maintenance end points (MEPs) such as up MEPs and down MEPs are configured. The configuration of MEPs across the network may help facilitate Layer 2 (L2) connectivity checks using continuity check message (CCM) protocol data units (PDUs). Network devices may include an interface configured as an up MEP and therefore sometimes referred to herein as an up MEP interface. For the purposes of continuity check, the up MEP may be used to check, among other things, the data plane bridging capability of the network device. In other words, the up MEP appropriately transmitting and/or receiving CCM PDUs may be indicative of continuity through the bridge implemented by the network device.

However, some network devices may be unable (e.g., due to hardware limitations such as the lack of an Operation, Administration, and/or Management (OAM) processor, lack of appropriate egress pipeline trapping functionality, lack of appropriate ingress pipeline injection functionality, etc.) to properly transmit and/or receive CCM PDUs when an up MEP is configured on these network devices. Even so, a user such as a network administrator may desire to implement the up MEP on these network devices (e.g., to be in compliance with certain standards or specifications, in brownfield deployments, etc.). Accordingly, in illustrative configurations described herein as examples, a network device may include control circuitry configured to perform control plane bridging, among other functions, to facilitate proper handling of CCM PDUs for transmission and reception when an up MEP is configured on the network device.

In particular, upon receiving a CCM PDU at a peer interface with respect to the up MEP interface, data plane processing circuitry (e.g., an ingress pipeline for the peer interface) may trap the CCM PDU and provide the trapped CCM PDU to the control circuitry for (software) control plane bridging, thereby bypassing the egress pipeline for the MEP interface (which may lack a functionality to trap the CCM PDU). In the transmission scenario, the control circuitry may generate the CCM PDU and perform (software) control plane bridging before injecting the CCM PDU into the appropriate egress pipeline for the peer interface and for egress from peer interface, thereby bypassing the ingress pipeline for the MEP interface (which may lack a functionality to receive the injected CCM PDU).

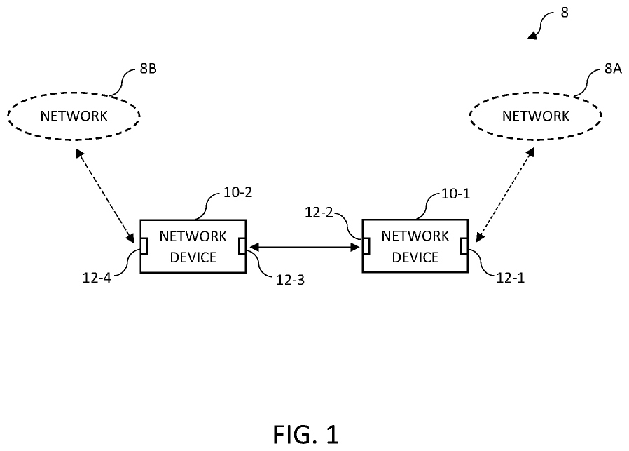

FIG. 1 is a diagram of an illustrative network in which one or more network devices are configured to perform L2 connectivity checks in a manner as described above (e.g., perform control plane bridging and other operations for appropriately processing CCM PDUs for an up MEP). Network 8 of FIG. 1 may be implemented using network devices that handle (e.g., process by modifying, forwarding, etc.) network traffic to convey information for management applications (e.g., connectivity fault management) between devices and/or for user applications between end hosts. In the example of FIG. 1, network 8 may include a first network device 10-1 and a second network device 10-2. Network device 10-1 may have first and second ports 12-1 and 12-2, whereas network device 10-2 may have first and second ports 12-3 and 12-4. Network interfaces (sometimes referred to herein as input-output interfaces) may be implemented using these ports. In particular, an interface implemented using port 12-2 may be communicatively coupled to a corresponding interface implemented using port 12-3. This communication link between network devices 10-1 and 10-2 may include other intervening network devices (or if desired, may be a direct link that excludes any intervening network devices). An interface implemented using port 12-1 may communicatively couple network device 10-1 to a network (portion) 8A of network 8, whereas an interface implemented using port 12-4 may communicatively couple network device 10-2 to a network (portion) 8B of network 8. In other words, network traffic may be conveyed between network portions 8A and 8B via network devices 10-1 and 10-2.

Network 8 may have any suitable scope. As examples, network 8 may include, be, and/or form part of one or more local segments, one or more local subnets, one or more local area networks (LANs), one or more campus area networks, a wide area network, etc. In particular, network 8 may be a wired network based on wired technologies or standards such as Ethernet (e.g., using copper cables and/or fiber optic cables) and may optionally include a wireless network such as a wireless local area network (WLAN). If desired, network 8 may include internet service provider networks (e.g., the Internet) or other public service provider networks, private service provider networks (e.g., multiprotocol label switching (MPLS) networks), and/or any other types of networks such as telecommunication service provider networks.

In some illustrative configurations described herein as an example, network portion 8A may include a core network (e.g., a service provider network) and network portion 8B may be one of multiple sites (e.g., customer sites) communicatively coupled to the core network. This example is merely illustrative. If desired, network devices 10-1 and 10-2 may be coupled between any two network portions of network 8 and/or various network devices (forming yet another network portion) may be coupled between network devices 10-1 and 10-2.

Network 8 can include networking equipment forming a variety of network devices that interconnect end hosts of network 8. These network devices such as network devices 10-1 and 10-2 may each be a switch (e.g., a multi-layer (Layer 2 and Layer 3) switch or a single-layer (Layer 2) switch), a bridge, a router, a gateway, a hub, a repeater, a firewall, a wireless access point, a network device serving other networking functions, a network device that includes the functionality of two or more of these devices, or management equipment that manages and controls the operation of one or more of these network devices. End hosts of network 8 can include computers, servers, portable electronic devices such as cellular telephones and laptops, other types of specialized or general-purpose host computing equipment (e.g., running one or more client-side and/or server-side applications), network-connected appliances or devices that serve as input-output devices and/or computing devices in a distributed networking system, devices used by network administrators (sometimes referred to as administrator devices), network service or analysis devices, management equipment that manages and controls the operation of one or more of other end hosts and/or network devices.

In the example of FIG. 1, two interfaces respectively on network devices 10-1 and 10-2 (e.g., an interface formed from port 12-1 and an interface formed from port 12-3) may be used to form two maintenance end points (MEPs) that are associated with each other and are in the same maintenance domain (level). If desired, network 8, depending on its scope, may include any suitable number of MEPs across multiple maintenance domain levels, each having one or more maintenance associations. A single maintenance association for a single maintenance domain level having a first MEP at network device 10-1 and a second MEP at network 10-2 is described herein as an illustrative example in order not to obscure the embodiments described herein.

Network devices 10-1 and 10-2 may be configured to perform connectivity fault management, or more specifically L2 continuity checks by each using its MEP to periodically transmit continuity check message (CCM) protocol data units (PDUs). The other partner MEP receiving the transmitted CCM PDUs may be indicative of proper connectivity. CCM PDUs may sometimes be described herein as CCM frames or (Ethernet or L2) CCM packets (e.g., framed packets or packets having frame headers). CCM PDUs may include multicast and/or unicast packets. When a given MEP does not receive the CCM PDU sent by the other partner MEP within a particular timeout time period, the connectivity fault management process (e.g., executing on processing circuitry) implementing the given MEP may determine that connectivity is lost with respect to the other partner MEP.

In some illustrative configurations described herein as an example, at least one of the MEPs at network devices 10-1 and 10-2 is configured as an up MEP (while the other partner MEP may be configured as a down or up MEP). As one illustrative example, an interface on port 12-1 may be configured to be an up MEP, an interface on port 12-2 may be configured to be (e.g., serve as) a peer interface to the (up MEP) interface on port 12-1, and an interface on port 12-3 may be configured to be a down MEP. A down MEP may transmit and receive CCM PDUs directly using the (down MEP) interface on which it is configured, while an up MEP may transmit and receive CCM PDUs using the (up MEP) interface on which it is configured, a locally implemented bridge, and a peer interface to the up MEP interface.

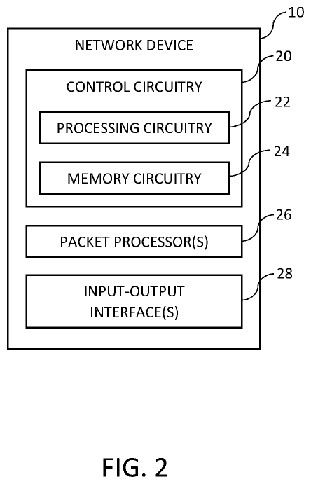

FIG. 2 is a diagram of an illustrative network device 10 used to implement network device 10-1, network device 10-2, and/or other network devices in network 8 in FIG. 1. As shown in FIG. 2, network device 10 may include control circuitry 20 having processing circuitry 22 and memory circuitry 24, one or more packet processors 26, and input-output interfaces 28. In one illustrative arrangement, network device 10 may be or form part of a modular network device system (e.g., a modular switch system having removably coupled modules usable to flexibly expand characteristics and capabilities of the modular switch system such as to increase ports, provide specialized functionalities, etc.). In another illustrative arrangement, network device 10 may be a fixed-configuration network device (e.g., a fixed-configuration switch having a fixed number of ports and/or a fixed hardware configuration).

Processing circuitry 22 may include one or more processors such as central processing units (CPUs), graphics processing units (GPUs), microprocessors, general-purpose processors, host processors, microcontrollers, digital signal processors, programmable logic devices such as field programmable gate array (FPGA) devices, application specific system processors (ASSPs), application specific integrated circuit (ASIC) processors, and/or other types of processors.

Processing circuitry 22 may run (e.g., execute) a network device operating system and/or other software/firmware that is stored on memory circuitry 24. Memory circuitry 24 may include one or more non-transitory (tangible) computer-readable storage media that store the operating system software and/or any other software code, sometimes referred to as program instructions, software, data, instructions, or code. As an example, the connectivity fault management operations (e.g., at least some of the transmission and/reception operations of CCM PDUs) described herein and performed by network device 10 may be stored as (software) instructions on the one or more non-transitory computer-readable storage media (e.g., in portion(s) of memory circuitry 24 in network device 10). The corresponding processing circuitry (e.g., one or more processors of processing circuitry 22 in network device 10) may process or execute the respective instructions to perform the corresponding connectivity fault management operations. Memory circuitry 24 may include non-volatile memory (e.g., flash memory, electrically-programmable read-only memory, a solid-state drive, hard disk drive storage, etc.), volatile memory (e.g., static or dynamic random-access memory), removable storage devices (e.g., storage devices removably coupled to device 10), and/or other types of memory circuitry.

Processing circuitry 22 and memory circuitry 24 as described above may sometimes be referred to collectively as control circuitry 20 (e.g., implementing a control plane of network device 10). Accordingly, processing circuitry 22 may also sometimes be referred to as control plane processing circuitry 22. As just a few examples, processing circuitry 22 may execute network device control plane software such as operating system software, routing policy management software, routing protocol agents or processes, routing information base agents, and other control software, may be used to support the operation of protocol clients and/or servers (e.g., to form some or all of a communications protocol stack), may be used to support the operation of packet processor(s) 26, may store packet forwarding information, may execute packet processing software, and/or may execute other software instructions that control the functions of network device 10 and the other components therein.

Packet processor(s) 26 may be used to implement a data plane or forwarding plane of network device 10 and may therefore sometimes be referred to herein as data plane processor(s) 26 or data plane processing circuitry 26. Packet processor(s) 26 may include one or more processors such as programmable logic devices such as field programmable gate array (FPGA) devices, application specific system processors (ASSPs), application specific integrated circuit (ASIC) processors, central processing units (CPUs), graphics processing units (GPUs), microprocessors, general-purpose processors, host processors, microcontrollers, digital signal processors, and/or other types of processors.

A packet processor 26 may receive incoming (ingress) network traffic via input-output interfaces 28, parse and analyze the received network traffic, process the network traffic based on packet forwarding decision data (e.g., in a forwarding information base) and/or in accordance with network protocol(s) or other forwarding policy, and forward (or drop) the network traffic accordingly. As just a few examples, the forwarded network traffic may include the original version and/or a mirrored version of the received network traffic, may be include an encapsulated (tunneled) or decapsulated version of the received network traffic, may include an encrypted or decrypted version of the received network traffic and/or may generally include a processed version of the received network traffic (based on any combination of mirroring, tunneling, encapsulation, decapsulation, encryption, decryption and other operations). The packet forwarding decision data may be stored on memory circuitry integrated as part of and/or separate from packet processor 26 (e.g., on content-addressable memory), and/or on a portion of memory circuitry 24. Memory circuitry for packet processor 26 may similarly include volatile memory and/or non-volatile memory.

Input-output interfaces 28 may include one or more different types of communication interfaces such as Ethernet interfaces, optical interfaces, wireless interfaces such as Bluetooth interfaces and Wi-Fi interfaces, and/or other communication interfaces for connecting network device 10 to the Internet, a local area network, a wide area network, a mobile network, and/or generally other network device(s), peripheral devices, and computing equipment (e.g., host equipment such as server equipment, client devices, etc.).

In illustrative configurations described herein as an example, input-output interfaces 28 may include Ethernet interfaces implemented using and therefore include (Ethernet) ports (e.g., ports 12-1, 12-2, 12-3, and 12-4 in FIG. 1). In particular, L2 interface circuitry may be coupled to ports to form Ethernet interfaces with the desired interface configuration. The ports may be physically coupled and electrically connected to corresponding mating connectors of external equipment, when received at the ports, and may have different form-factors to accommodate different cables, different modules, different devices, or generally different external equipment.

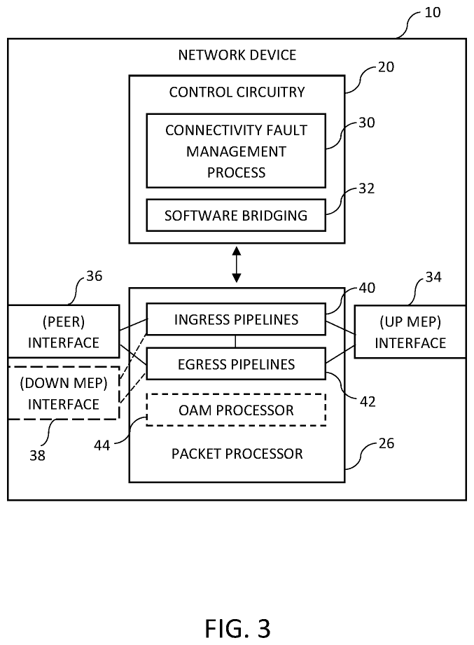

As described in connection with FIG. 1, network devices 10-1 and 10-2 may each be configured to perform connectivity fault management operations (e.g., by implementing MEPs and using the MEPs to perform L2 continuity checks). FIG. 3 is a diagram of an illustrative configuration of a network device 10 (e.g., that further details the configuration of device 10 in FIG. 2) for performing connectivity fault management. Network device 10 in FIG. 3 may be usable for implementing any network device on which at least one up MEP is configured (e.g., network device 10-1 in FIG. 1). If desired, network device 10 in FIG. 3, with some modifications (e.g., with the configuration of down MEP interface 38 instead of or in addition to up MEP interface 34 and peer interface 36), may similarly be usable to implement any network device on which at least one down MEP is implemented (e.g., network device 10-2 in FIG. 1).

As shown in FIG. 3, control circuitry 20 may implement a connectivity fault management process 30 (sometimes referred to as a connectivity fault management agent or connectivity fault management service). In particular, control circuitry 20 may implement connectivity fault management process 30 by control circuitry 20, or more specifically processing circuitry 22 (FIG. 2) of control circuitry 20, executing (software) instructions stored on memory circuitry 24 (FIG. 2). Among other operations performed by control circuitry 20 (e.g., as part of process 30), control circuitry 20 may configure (e.g., generate, implement, etc.) one or more MEPs on corresponding interface(s) 28 (FIG. 2) of network device 10 (e.g., by associating a MEP with the corresponding interface on which it is formed, by storing an indication of a maintenance domain level of the MEP, an indication of whether the MEP is an up MEP or down MEP, and other information associated with the MEP, etc.), may generate CCM PDUs for each of the locally configured MEPs that are destined for remote MEPs configured on interfaces of external (remote) network devices, may receive CCM PDUs destined for local MEPs originating from remote MEPs, may process the received CCM PDUs to determine proper L2 continuity for the maintenance association, may send notifications or take other actions when appropriate CCM PDUs are not received within a timeout time period, etc.

As described herein, operations performed as part of connectivity fault management process 30 (e.g., by control circuitry 20 and/or using one or more other components in device 10 such as interfaces 28) may include operations in compliance with or generally compatible with at least some portions of Connectivity Fault Management as specified by the IEEE 802.1ag standard and/or may include other types of operations (e.g., the use of control plane bridging, the use of peer ingress pipeline trapping, the use of peer egress pipeline injection, etc., as further detailed herein). As referred to herein, an up MEP may be an Up MEP as specified by the IEEE 802.1ag standard and/or may generally be a MEP configured to exchange CCM PDUs through a locally implemented bridging functionality (when there is proper L2 continuity to the MEP). As referred to herein, CCM PDUs may have formats that are in compliance with the IEEE 802.1ag standard (e.g., continuity check messages in a frame format in compliance with the Continuity Check Protocol) and/or may include custom fields and/or value or generally be messages conveyed between MEPs.

To facilitate the detection of L2 connectivity issues between two points within a network (e.g., network 8 in FIG. 1), control circuitry 20 of respective network devices 10 (e.g., when executing corresponding instances of connectivity fault management process 30) may configure interfaces 28 (FIG. 2) on the respective network devices 10 to serve as MEPs. In an illustrative configuration described herein as an example, network device 10 in FIG. 3 may be network device 10-1 in FIG. 1. Control circuitry 20 of network device 10-1 may configure a first input-output interface 28 (FIG. 2), e.g., using port 12-1 (FIG. 1), as an up MEP. Accordingly, this first input-output interface 28 may sometimes be referred to herein as up MEP interface 34. In particular, the configuration of up MEP interface 34 may include process 30 and/or interface 28 storing an association between an up MEP instance and interface 34. Because up MEP interface 34 transmits and receives continuity check messages through a different interface (and through the internal bridging functionality of network device 10), control circuitry 20 of network device 10-1 may configure one or more additional input-output interfaces 28 (FIG. 2), e.g., using port 12-2 (FIG. 1), as one or more peer interfaces 36 with respect to up MEP interface 34. If desired, control circuitry 20 of network device 10-1 may also configure one or more down MEP interfaces 38 (and/or additional up MEP interfaces).

Packet processor(s) 26 may generally be provided between input-output interfaces 28 of network device 10 (e.g., between a peer interface 36 and an up MEP interface 34). Packet processor 26 may include packet processing pipelines. These packet processing pipelines may include one or more ingress pipelines 40 and one or more egress pipelines 42. An ingress or egress pipeline may include a parser that parses header information of a received packet, a processing engine configured to modify information on the packet (based on the parsed header information), and a selector that forwards the packet to a downstream element (e.g., a selector for an ingress pipeline 40 may output the packet to an appropriate egress pipeline 42, a selector for an egress pipeline 42 may output the packet to an appropriate egress interface).

A packet processor (e.g., the processing pipelines therein) may typically be used to process CCM PDUs for an up MEP (e.g., CCM PDUs received from a remote MEP and destined for the local up MEP and CCM PDUs from the local up MEP and destined for the remote MEP). However, in some network device configurations, this may not be possible. As an example, network device 10 in FIG. 3 may include data plane processing circuitry 26 which lacks certain hardware and/or hardware capabilities for processing CCM PDUs for an up MEP. In particular, data plane processing circuitry 26 may lack an operation, administration, and/or management (OAM) processor 44, or more specifically, a processor that handles continuity check protocol and/or the processing of CCM PDUs for the up MEP interface, may not support packet trapping on the egress pipeline(s) for the up MEP interface, and/or may not support packet injection on the ingress pipeline(s) for the up MEP interface. Without more, such a network device may be unable to handle CCM PDUs for the up MEP even when such a capability is desired by a user (e.g., to facilitate L2 continuity checks, e.g., by using Continuity Check Protocol, or generally to perform Connectivity Fault Management as specified by the IEEE 802.1ag).

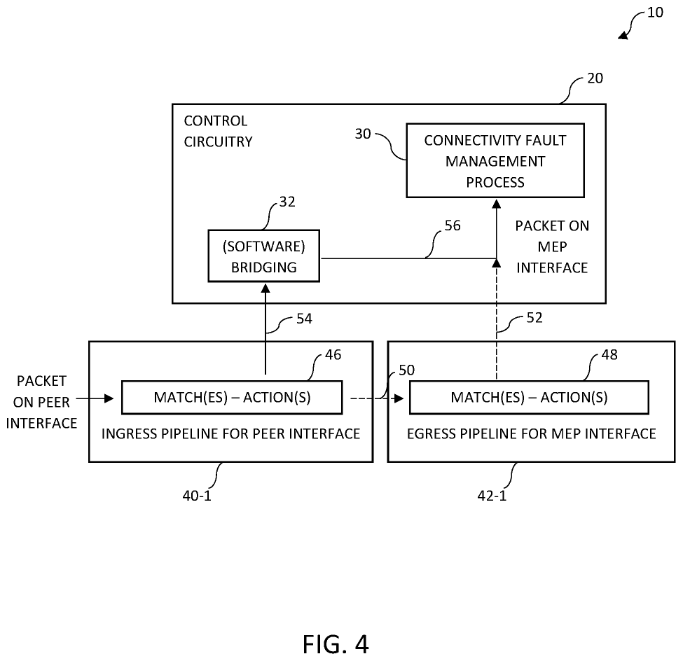

To provide CCM PDU handling for an up MEP on a network device that lacks certain hardware and/or hardware functionalities as described above (or generally to provide CCM PDU handling for an up MEP on any network device), an illustrative network device such as network device 10 in FIG. 3 may include a software bridging process configured to perform software bridging 32 (sometimes referred to herein as control plane bridging 32), e.g., by control circuitry 20, or more specifically processing circuitry 22 (FIG. 2) of control circuitry 20, executing (software) instructions stored on memory circuitry 24 (FIG. 2). Network device 10 in FIG. 3 may also convey CCM PDUs in manners that bypass certain portions of data plane processing circuitry 26 that lack the appropriate CCM PDU handling functionalities. Portions of control circuitry 20 may be communicatively coupled to data plane processing circuitry 26 to facilitate the processing of CCM PDUs described herein. An illustrative example for the processing of a CCM PDU received at peer interface 36 for conveyance to the up MEP at process 30 (while bypassing up the egress pipeline for up MEP interface 34) is described in connection with FIGS. 4-6.

As shown in FIG. 4, a peer interface such as peer interface 36 in FIG. 3 may receive a packet such as a CCM PDU from a remote MEP that is destined for the up MEP. The CCM PDU may be passed to ingress pipeline 40-1 for peer interface 36. Ingress pipeline 40-1 may include a processing engine implementing one or more match-and-action processing blocks 46 based on which the CCM PDU is processed (e.g., forwarded). As part of the forwarding operation for the CCM PDU, header information parsed by a parser of pipeline 40-1 may be used as search/lookup keys for data tables to enable the performance of appropriate operations at the processing block(s) 46. As examples, the appropriate operations may typically include generating metadata indicative of an egress pipeline to which the packet should be directed to or other packet metadata (e.g., whether or not to bridge or route the packet, whether or not add a tunnel header, etc.), obtaining editing instructions that are fed into block(s) 46 to direct editing actions on the packet, and/or other operations.

While, for some types of packets, ingress pipeline 40-1 may provide the processed packets to an egress pipeline 42-1 (as indicated by dashed arrow 50), this may not be desirable for the CCM PDU in configurations in which corresponding match-and-action processing blocks 48 at egress pipeline 42-1 for MEP interface 34 (FIG. 3) lack the functionality to trap the CCM PDU for conveyance to process 30 at control circuitry 20 (as indicated by dashed arrow 52) and/or lack the functionality to perform continuity check protocol or the processing of CCM PDUs directly in the data plane (e.g., lack OAM processor 44 in FIG. 3).

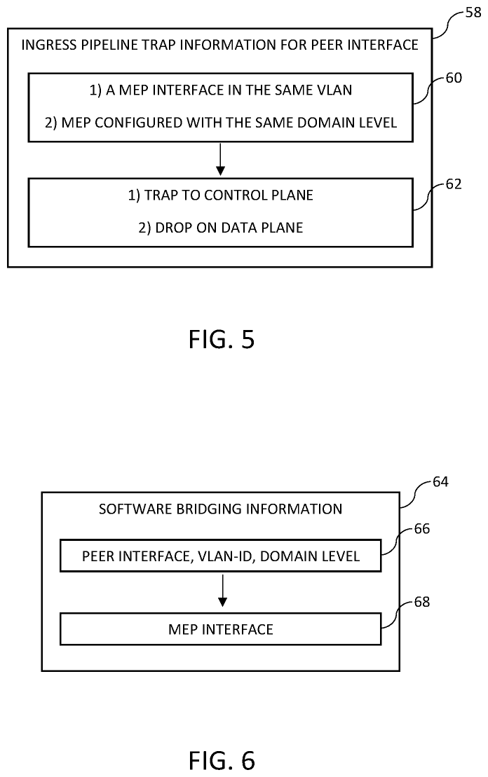

Accordingly, ingress pipeline 40-1 (e.g., a given processing block 46 at ingress pipeline 40-1) may be configured to trap the CCM PDU for conveyance to control circuitry 20 (as indicated by arrow 54). In particular, FIG. 5 is a diagram of illustrative ingress pipeline trap information based on which ingress pipeline 40-1 for peer interface 36 may process the CCM PDU. Trap information 58 shown in FIG. 5 may be stored as one or more entries in a trap table and/or a forwarding table on memory circuitry (e.g., described in connection with FIG. 2) associated with data plane processing circuitry 26. As shown in the example of FIG. 5, trap information 58 may include one or more criteria such as first and second matching criteria 60. The first matching criterion 60 may be based on whether or not any (up) MEP interfaces are implemented on the same virtual local area network (VLAN) as the peer interface at which the CCM PDU is received. The second matching criterion 60 may be based on whether any of these (up) MEP interfaces are configured with the same maintenance domain level as the maintenance domain level identified in the CCM PDU.

In response to determining the existence of an up MEP interface (e.g., up MEP interface 34) on the same VLAN as the peer interface (e.g., peer interface 36) and having a maintenance domain (level) that is the same as the maintenance domain (level) identified by the CCM PDU, ingress pipeline 40-1 (FIG. 4) may take one or more suitable actions such as first and second actions 62. In particular, ingress pipeline 40-1 may trap the CCM PDU for conveyance to control circuitry 20 (indicated by arrow 54 in FIG. 4) and may drop the CCM PDU on the data plane (e.g., not forward the CCM PDU egress pipeline 42-1 (as indicated by dashed arrow 50) and therefore not forward the CCM PDU to the egress side of MEP interface 34). Accordingly, processing of the CCM PDU may bypass egress pipeline 42-1 and MEP interface 34.

Referring back to FIG. 4, upon receiving the trapped CCM PDU from ingress pipeline 40-1, control circuitry 20 may perform control plane bridging 32 for the received CCM PDU. Control circuitry 20 performs control plane bridging 32 in place of a bridging operation that would have been performed by a hardware-based bridge implemented as part of data plane processing circuitry 26. Subsequent to the bridging, the CCM PDU may be passed to connectivity fault management process 30 (as indicated by arrow 56) as if the CCM PDU were bridged to and processed by egress pipeline 42-1 and may be received on the up MEP implemented by process 30. The reception of the CCM PDU at the up MEP may facilitate corresponding continuity fault management operations performed by process 30 (e.g., reset of a timeout time period).

FIG. 6 is a diagram of illustrative software bridging information such as information 64 used to bridge the CCM PDU to the MEP interface. Bridging information 64 may be part of a bridging table stored on memory circuitry 24 (FIG. 2) or other memory circuitry (e.g., used by data plane processing circuitry 26). As shown in FIG. 6, bridging information 64 may include key information 66 and value information 68. In particular, control circuitry 20 (as part of performing control plane bridging 32 in FIG. 4) may use a peer interface (identifier) from which the CCM PDU is received, a VLAN identifier in the CCM PDU, and a maintenance domain level identified in the CCM PDU as keys (e.g., key information 66) in a lookup operation to identify a corresponding MEP interface (identifier) as a value or result of the lookup operation (e.g., value information 68). Accordingly, control circuitry 20 may bridge the CCM PDU to the MEP interface and subsequently for conveyance to the up MEP at process 30 (e.g., as if the CCM PDU were bridged to egress pipeline 42-1 and received by the up MEP from egress pipeline 42-1).

While VLAN mapping information (e.g., the use of the VLAN identifier as a key in the lookup operation) is described in connection with FIG. 6, this is merely illustrative. If desired, other suitable information such as tunnel information (e.g., tunnel header information in the CCM PDU) or other encapsulated information may be used as a key (e.g., instead of the VLAN information) in the lookup operation to identify the corresponding MEP interface as value information 68. In general, in instances in which the CCM PDU lacks a VLAN identifier (or tunnel information), a different set of information (e.g., information in the CCM PDU and/or metadata information generated by ingress pipeline 40-1 when processing the CCM PDU) may be used as key information 66 to identify the corresponding MEP interface (identifier) as information 68.

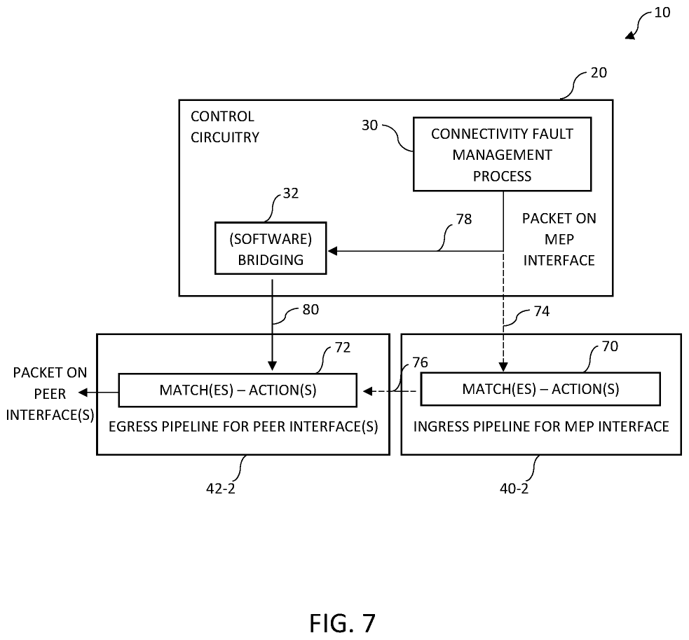

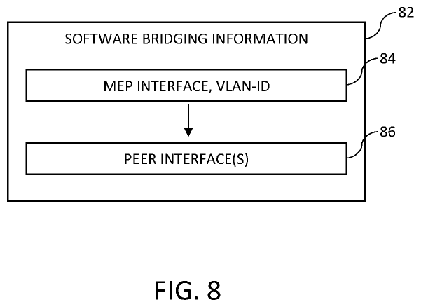

An illustrative example for processing of a CCM PDU generated at the up MEP for conveyance to peer interface 36 (while bypassing the ingress pipeline for up MEP interface 34) is described in connection with FIGS. 7 and 8.

As shown in FIG. 7, when transmitting a CCM PDU from an up MEP that is destined for a remote MEP, control circuitry 20 (e.g., connectivity fault management process 30) may generate the CCM PDU for the up MEP (e.g., originating at the up MEP). In some instances, it may be desirable to inject the generated CCM PDU to ingress pipeline 40-2 for up MEP interface 34 associated with the up MEP (as indicated by dashed arrow 74) such that the CCM PDU is then bridged to egress pipeline 42-2 for peer interface 36 (as indicated by dashed arrow 76). However, this may not be possible in configurations in which corresponding match-and-action processing blocks 70 at ingress pipeline 40-2 for MEP interface 34 (FIG. 3) lack the functionality to receive the CCM PDU injected by control circuitry 20 and/or lack the functionality to perform continuity check protocol or the processing of CCM PDUs directly in the data plane (e.g., lack OAM processor 44 in FIG. 3).

Accordingly, the software bridging process on control circuitry 20 may receive the generated CCM PDU (as indicated by arrow 78) and perform control plane bridging 32 in place of a bridging operation that would have been performed by a hardware-based bridge implemented as part of data plane processing circuitry 26. Subsequent to the bridging, the CCM PDU may be injected into (e.g., conveyed or sent to) egress pipeline 42-2 for a peer interface such as peer interface 36 (as indicated by arrow 80).

A given egress pipeline 42-2 for peer interface 36 may include a processing engine implementing one or more match-and-action processing blocks 72 based on which the injected CCM PDU is processed (e.g., forwarded). In particular, the CCM PDU may be injected into a given processing block 72 and may be forwarded by one or more downstream processing blocks 72 before being egressed at peer interface 36.

FIG. 8 is a diagram of illustrative software bridging information such as information 82 used to bridge the CCM PDU to the peer interface. Bridging information 82 may be part of a bridging table stored on memory circuitry 24 (FIG. 2) or other memory circuitry (e.g., used by data plane processing circuitry 26). As shown in FIG. 8, bridging information 82 may include key information 84 and value information 86. In particular, control circuitry 20 (as part of performing control plane bridging 32 in FIG. 7) may use the MEP interface (identifier) associated with the up MEP on which the CCM PDU is generated and a VLAN identifier in the generated CCM PDU as keys (e.g., key information 84) in a lookup operation to identify one or more corresponding peer interfaces as value(s) or result(s) of the lookup operation (e.g., value information 86). Accordingly, control circuitry 20 may bridge the CCM PDU to the peer interface(s) (e.g., respective egress pipelines 42-2 of the peer interfaces) and subsequently for egressing the CCM PDU from the peer interface(s) toward the remote MEP(s) (e.g., as if the CCM PDU were injected into ingress pipeline 40-2 and received by egress pipeline(s) 42-2 from ingress pipeline 40-2).

While VLAN mapping information (e.g., the use of the VLAN identifier as a key in the lookup operation) is described in connection with FIG. 8, this is merely illustrative. If desired, other suitable information such as tunnel information (e.g., tunnel header information in the CCM PDU) may be used as a key (instead of the VLAN information) in the lookup operation to identify the corresponding peer interface as value information 86.

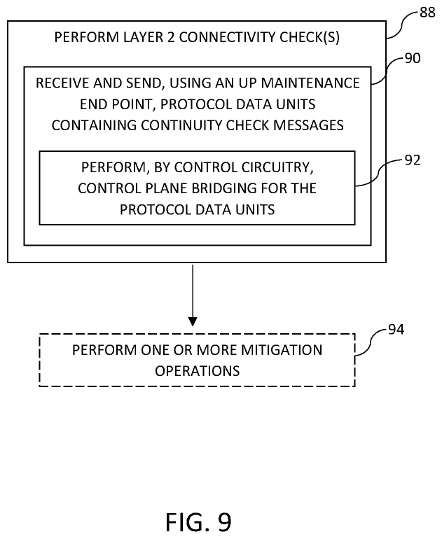

FIG. 9 is a flowchart of illustrative operations for performing connectivity fault management. These operations may be performed using one or more network devices in network 8 such as network device 10-1 described in connection with FIG. 1 and/or network device 10 described in connection with FIGS. 2-8 and/or other elements of the networking system in FIG. 1.

In configurations described herein as an illustrative example, the operations described in connection with FIG. 9 may be performed by control circuitry 20 in network device 10 (e.g., performed by processing circuitry 22 in network device 10 by executing software instructions stored on memory circuitry 24 in FIG. 2) and/or performed by data plane processing circuitry 26. If desired, one or more operations described in connection with FIG. 9 may be performed using other dedicated hardware components in network device 10 (e.g., by control circuitry 20 in network device 10 controlling or using these other dedicated hardware components such as L2 interface circuitry).

At block 88, control circuitry on network device 10 (e.g., control circuitry 20 in FIGS. 2 and 3) may perform L2 connectivity checks between a local MEP and a remote MEP. As an example, L2 connectivity checks may be performed by connectivity fault management process 30 in FIG. 3. To facilitate these checks, the control circuitry may implement or configure a local MEP by associating the local MEP with a corresponding network interface of network device 10 and storing type information associated with the implemented local MEP such as a maintenance domain (level or identifier) of the local MEP, the local MEP being an up MEP, etc., as described in connection with FIG. 3.

As part of the L2 connectivity checks, at block 90, the control circuitry may periodically receive and send, using a configured up MEP, protocol data units (e.g., PDUs) containing continuity check messages (CCMs). The reception of PDUs by the up MEP may be used to indicate to the connectivity fault management process implemented on the processing circuitry that the L2 connectivity between the local up MEP and the remote MEP is intact. The transmission of PDUs by the up MEP (when properly received by the remote MEP) may be used to indicate to the remote network device on which the remote MEP is implemented that the L2 connectivity between the local up MEP and the remote MEP is intact.

To properly process PDUs for up MEPs (especially in scenarios in which network device 10 has certain hardware limitations), the control circuitry may perform, among other operations, control plane bridging for the PDUs (at block 92).

As a first example, to facilitate the reception of PDUs by the up MEP, the control circuitry may perform control plane bridging in the manner described in connection with FIGS. 4 and 6. Additionally, the control circuitry may configure or otherwise control data plane processing circuitry of network device 10 (e.g., ingress pipeline 40-1 in FIG. 4) to trap the PDUs for the control circuitry (and drop the PDUs in the data plane) in the manner described in connection with FIGS. 4 and 5, e.g., by maintaining trap information 58 on corresponding memory circuitry accessibly by ingress pipeline 40-1. The control circuitry may further provide the bridged PDUs to the up MEP at the connectivity fault management process in the manner described in connection with FIG. 4. This type of processing of PDUs may bypass the egress pipeline of the up MEP interface but may still appear to the up MEP at the connectivity fault management process as if the PDUs were processed by the egress pipeline of the up MEP interface.

As a second example, to facilitate the transmission of PDUs by the up MEP, the control circuitry may perform control plane bridging in the manner described in connection with FIGS. 7 and 8. Additionally, the control circuitry may generate the PDUs for transmission at the up MEP prior to control plane bridging the generated PDUs and may inject the bridged PDUs into the egress pipeline for the peer interface in the manner described in connection with FIG. 7. This type of processing of PDUs may bypass the ingress pipeline of the up MEP interface but may still appear to the peer interface (e.g., the egress pipeline of the peer interface) as if the PDUs were processed (e.g., bridged) by the ingress pipeline of the up MEP interface.

Responsive to performing L2 connectivity checks, the control circuitry (e.g., the connectivity fault management process implemented thereon) may determine that a L2 connection between the local MEP and the remote MEP is no longer intact and is lost. In response to this determination, at block 94, the control circuitry may optionally perform one or more mitigation operations. As examples, the one or more mitigation operations may include sending an indication of the loss of connection to other processes (e.g., routing processes) executing on the control circuitry, re-configuring data plane processing circuitry (e.g., updating stored forwarding information used by the data plane processing circuitry), and/or sending an indication of the loss of connection to external devices (e.g., to an administrator device, to a controller, to another network device, etc.).

The methods and operations described above in connection with FIGS. 1-9 may be performed by the components of a network device using software, firmware, and/or hardware (e.g., dedicated circuitry or hardware). Software code for performing these operations may be stored on one or more non-transitory computer readable storage media (e.g., tangible computer readable storage media) stored on one or more of the components of the network device. The software code may sometimes be referred to as software, data, instructions, program instructions, or code. The one or more non-transitory computer readable storage media may include drives, non-volatile memory such as non-volatile random-access memory (NVRAM), removable flash drives or other removable media, other types of random-access memory, etc. Software stored on the non-transitory computer readable storage media may be executed by processing circuitry on one or more of the components of the network device (e.g., processing circuitry 22 in FIG. 2, control plane processing circuitry 26 of FIG. 2, etc.).

The foregoing is merely illustrative and various modifications can be made to the described embodiments. The foregoing embodiments may be implemented individually or in any combination.

What is claimed is:

1. A network device comprising:
a first input-output interface configured as a maintenance end point (MEP) interface;
a second input-output interface configured as a peer interface for the MEP interface;
a packet processor coupled to the first and second input-output interfaces and configured to handle a continuity check message (CCM) protocol data unit (PDU) for the MEP interface; and
control circuitry coupled to the packet processor and configured to perform control plane bridging for the CCM PDU.

2. The network device defined in claim 1, wherein the control circuitry is configured to associate an up MEP with the first input-output interface to configure the first input-output interface as the MEP interface.

3. The network device defined in claim 2, wherein the CCM PDU is received at the second input-output interface, wherein the packet processor comprises an ingress pipeline for the second input-output interface, and wherein the ingress pipeline is configured to process the CCM PDU by trapping the CCM PDU and sending the CCM PDU to the control circuitry.

4. The network device defined in claim 3, wherein the ingress pipeline is configured to process the CCM PDU by dropping the CCM PDU based on identifying the up MEP as being in a maintenance domain identified in the CCM PDU and being in a same virtual local area network (VLAN) as the second input-output interface.

5. The network device defined in claim 4, wherein the control circuitry is configured to perform connectivity fault management at least in part by providing, after performing control plane bridging for the CCM PDU, the CCM PDU to the up MEP.

6. The network device defined in claim 2, wherein the control circuitry is configured to perform connectivity fault management at least in part by generating the CCM PDU at the up MEP.

7. The network device defined in claim 6, wherein the packet processor comprises an egress pipeline for the second input-output interface and wherein the control circuitry is configured to send the CCM PDU to the egress pipeline after performing control plane bridging for the CCM PDU.

8. The network device defined in claim 7, wherein the egress pipeline is configured to provide the CCM PDU to the second input-output interface for egress.

9. The network device defined in claim 1, wherein the control circuitry is configured to store virtual local area network (VLAN) or tunnel information and wherein the control circuitry is configured to perform control plane bridging for the CCM PDU based on the VLAN or tunnel information.

10. The network device defined in claim 1, wherein the packet processor lacks an Ethernet Operations, Administration, and Maintenance (OAM) processor.

11. The network device defined in claim 1, wherein the packet processor does not support packet trapping on an egress pipeline for the first input-output interface or does not support packet injection on an ingress pipeline for the first input-output interface.

12. A network device comprising:
a first network interface;
a second network interface;
data plane processing circuitry comprising an ingress pipeline for the second network interface; and
control circuitry configured to implement an up maintenance end point (MEP) on the first network interface, wherein the ingress pipeline for the second network interface is configured to trap a continuity check message (CCM) protocol data unit (PDU) received at the second network interface and destined for the up MEP and provide the trapped CCM PDU to the control circuitry for conveyance to the up MEP.

13. The network device defined in claim 12 further comprising:
memory circuitry configured to store trap information for the ingress pipeline, wherein the ingress pipeline is configured to trap the CCM PDU to a control plane in response to determining that the up MEP is on a same virtual local area network (VLAN) as the second network interface and that the up MEP is associated with a maintenance domain identified in the CCM PDU.

14. The network device defined in claim 13, wherein the ingress pipeline is configured to drop the CCM PDU in a data plane in response to determining that the up MEP is on the same VLAN as the second network interface and that the up MEP is associated with the maintenance domain identified in the CCM PDU.

15. The network device defined in claim 14, wherein the control circuitry is configured to store VLAN mapping information or tunnel information that identifies the first network interface based on traffic header information, wherein the control circuitry is configured to perform control plane bridging, based on the stored information, to identify the first network interface associated with the up MEP, and wherein the control circuitry is configured to provide the CCM PDU to the up MEP after performing control plane bridging based on the stored information.

16. The network device defined in claim 12, wherein the data plane processing circuitry comprises an egress pipeline for the first network interface and wherein the CCM PDU received at the second network interface and destined for the up MEP implemented on the first network interface bypasses the egress pipeline for the first network interface to arrive on the control circuitry.

17. A network device comprising:
a first network interface;
a second network interface;
data plane processing circuitry comprising an egress pipeline for the second network interface; and
control circuitry configured to implement an up maintenance end point (MEP) on the first network interface and configured to generate a continuity check message (CCM) protocol data unit (PDU) originating from the up MEP and inject the CCM PDU into the egress pipeline for the second network interface, wherein the CCM PDU is egressed from the second network interface and is destined for a remote MEP.

18. The network device defined in claim 17, wherein the control circuitry is configured to store VLAN mapping information or tunnel information that identifies the second network interface based on traffic header information and wherein the control circuitry is configured to perform control plane bridging, based on the stored information, to identify the second network interface serving as a peer interface to the up MEP.

19. The network device defined in claim 18, wherein the control circuitry is configured to inject the CCM PDU into the egress pipeline for the second network device after performing control plane bridging based on the stored information.

20. The network device defined in claim 17, wherein the data plane processing circuitry comprises an ingress pipeline for the first network interface and wherein the CCM PDU originating from the up MEP implemented on the first network interface bypasses the ingress pipeline to arrive on the egress pipeline for the second network interface.
